(19) United States
(12) Patent Application Publication
(10) Pub. No.: US 2008/0306843 A1
(43) Pub. Date: Dec. 11, 2008

(54) Cost effective methods to reduce tax avoidance by landlords, small businesses, and individuals

(76) Inventor: Chevine Arthur Miller, Plainfield, NJ (US)

Correspondence Address: Syunix Professional Services, 60 Sanford Ave, Plainfield, NJ, 07060, US

(21) Appl. No.: 11/761,305

(22) Filed: Jun. 11, 2007

(51) Int. Cl. G06Q 40/00

(52) U.S. Cl. 705/30

(57) ABSTRACT

To allow tax collection agencies to identify underreporting of income by individuals, landlords and vendors, new methods have been developed to ensure that tax revenues are reported accurately and lay the foundation for sharing data amongst the different agencies. Presently, cost effective methods do not exist to ensure that individuals, landlords, and vendors are obeying the tax laws.

### CROSS-REFERENCES TO RELATED APPLICATIONS

None

### STATEMENT REGARDING FEDERALLY SPONSORED RESEARCH OR DEVELOPMENT

None

### THE NAMES OF THE PARTIES TO A JOINT RESEARCH AGREEMENT

None

### INCORPORATION-BY-REFERENCE OF MATERIAL SUBMITTED ON A COMPACT DISC

None

### BACKGROUND OF THE INVENTION

1. Field of the Invention

The present invention pertains to developing cost effective methods that can be implemented by tax collection agencies to verify the tax revenues for individuals, landlords, and some businesses. Also, it lays the foundation for allowing governmental agencies to build a centralized database to determine who resides in the United States.

A practical example of the invention allows tax collection agencies to use cost effective methods to identify individuals and businesses that are not complying with the tax laws. Presently, individual taxpayers and businesses do not provide enough information to ensure that they are complying with the tax laws. Unless each individual taxpayer, landlord and business is audited, cost effective methods do not exist to identify fraudulent tax returns.

2. Description of the Related Art

It is known in the prior act that tax collection agencies rely upon individuals and businesses to accurately report income and deductions. Since tax collection agencies depend upon the honor system for certain individuals and businesses to report their taxable revenues and expenses, the information that is required to verify some of this information is not available. Landlords, tax avoiders, and general contractors are notorious for not reporting all of their taxable income. Since landlords know that tenants do not report that monthly rental payments, some landlords know that they can probably underreport some or all of their rental income. To reduce the amount of money that has to be reported for a work project, some contractors ask homeowners to pay for part of the work project with cash. If a contractor receives cash, he may be tempted to not report that income. Since tax collection agencies do not have the manpower or the tools to verify the deductions for landlords, some landlords may attempt to claim fraudulent business deductions.

As a landlord, the landlord simply has to state the amount of rental income for each rental property. Tenants do not have a way of reporting their payments to landlords. Since a mechanism does not exist to verify the rental income that has been reported by landlords, the possibility exists that some landlords may intentionally underreport rental income. Since many individuals know that tax collection agencies can not easily identify them or employers will not report employees that are not officially on their payrolls, many tax avoiders do not feel compelled to comply with the law.

One of biggest deductions for landlords involves renovations and repairs for rental properties. Even though landlords report that payments were made for these repairs and renovations, cost effective methods do not exist to confirm that landlords actually paid for these services. Basically, tax collection agencies rely upon landlords for accurate reporting.

When a house is placed into service as a rental property, tax collection agencies rely upon landlords to provide a brief description of rental properties. In certain localities, landlords have been known to convert dwellings into illegal housing. Many communities are complaining that landlords are converting single family and multi-family houses into boarding houses. Some of the landlords have even converted basements and attics into illegal apartments. Since tax collection agencies do not have the ability to confirm the actual number of apartments at rental properties, the possibility exists that landlords will not report all of income for apartments on a rental property.

In order for tax collection agencies to collect all of the tax revenues that are due, it is necessary to identify and prevent all of the individuals and businesses that are failing to comply with the tax laws. Individuals and businesses avoid complying with the tax laws by “working off the books” or using another person's tax identification number. If that person is “working off the books” or in the country illegally, the probability is very high that tax collection agencies are not aware of that person and the employer are not accurately reporting revenue.

### BRIEF SUMMARY OF THE INVENTION

The purpose of the invention is to provide tax collection agencies with cost effective methods to ensure that landlords, individual tax payers, and small businesses comply with the tax laws. By requiring these groups to provide additional information, tax collection will be able to develop software applications to analyze the data for fraudulent tax returns. By implementing this invention, a centralized database can be generated to provide vital information to other governmental agencies.

### BRIEF DESCRIPTION OF THE SEVERAL VIEWS OF THE DRAWINGS

FIG. 1. Information that landlord provides for new tenants

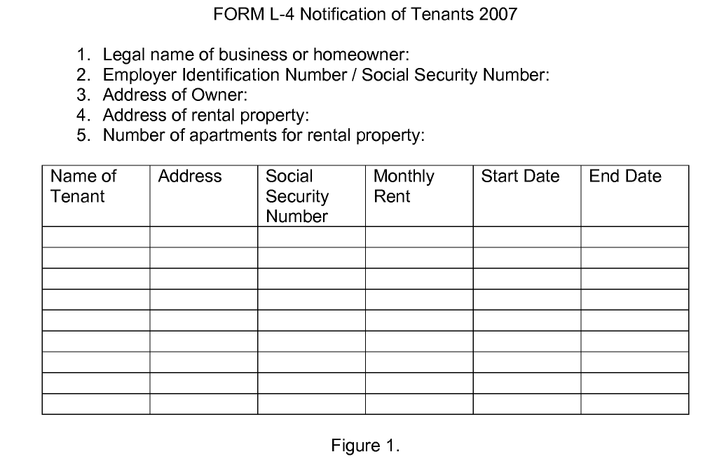

FIG. 2. Summary of rental payments to landlords

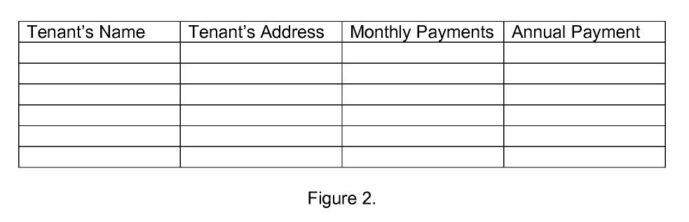

FIG. 3. Summary of payments that landlord made to all of its vendors

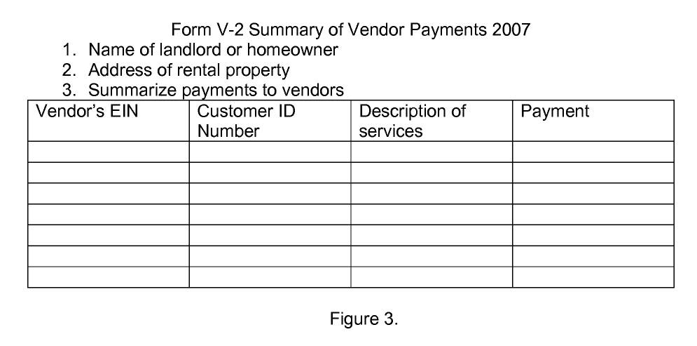

FIG. 4. Summary of revenue received from customers

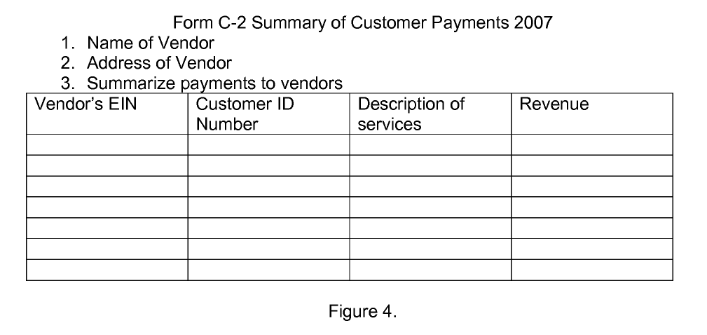

### DETAILED DESCRIPTION OF THE INVENTION

Presently, tax collection agencies depend upon individuals and businesses to accurately report income and deductions. Unless an individual or business is audited and investigated, a tax collection agency does not know whether or not the income and deductions are accurate. Since tax collection agencies do not have the resources to audit every tax return, the possibility exists that individuals and businesses may submit fraudulent claims knowing that tax collection agencies may not be able to audit or verify their tax returns. In fiscal year 2006, the IRS was only able to audit 257,000 individuals that had incomes over $100,000 and to audit 17,015 individuals with income over $1,000,000.

The purpose of the present invention is to accomplish the following tasks: (1) Provide a method to reduce the ability of individual taxpayers to avoid filing tax returns, (2) Provide a method for tax collection agencies to identify landlords that are underreporting rental income, (3) Provide a method for tax collection agencies to verify that some of the deductions are accurate, (4) Provide a method for tax collection agencies to verify that businesses, that provide services to homeowners and landlords, accurately report revenues from homeowners, and (5) Provide a method for exchanging non-confidential information to other governmental agencies.

Under the present system, tax collection agencies assume that every business will file a W-2 form for each employee and every eligible individual receives a W-2 form. If a business submits a W-2 form for an employee and the employee does not file a tax return, a tax collection agency should detect the non-filing as a problem. If an employee files a return and the employer does not submit a W-2 form for the employee, a tax collection agency should detect this as problem with the employee or the employer. What happens when the employee does not file a tax return and the employer does not submit a W-2 form for the employee? It is highly lightly that tax collection agencies will not be able to detect the non-compliance of the employer and the employee.

To ensure that every potential taxpayer files a tax return, tax collection agencies must be aware of everyone that is in the country legally and illegally. Since everyone requires some form of housing, the present invention will require landlords to report everyone that as the tenants occupy their rental properties. Also, homeowners and tenants will be required to report everyone that is living in their households. By having landlords report the identities of tenants, tax collection agencies can confirm that the residents are filing tax returns. If an eligible tax filer knows that landlords and homeowners are required to report their presence, they are aware that they know that it will be more difficult to hide from tax collection agencies. If a landlord/homeowner reports that a tenant exists and the tenant does not file a tax return, tax agencies will be aware that the individual exists and has not filed a tax return. If an individual files a tax return and a landlord or homeowner was not reported as a tenant, the possibility exists that the landlord/homeowner may be attempting to hide rental income. To ensure that landlords, tenants, and homeowners comply, stiff penalties and rewards should be used to ensure compliance.

Another problem that tax collection agencies face involves the underreporting of rental income from landlords and rental payments from close family members. Many landlords and homeowners that may receive rental income from relatives and friends may feel that they do not have to report these payments as income.

In geographical locations, where affordable housing is scarce, many landlords will illegally subdivide single and multi-family houses in boarding houses. Even though a house is registered on a property tax roll as a single, two, or three family house does not actually mean that this is the actual number of apartments in that dwelling. It is well documented that unscrupulous landlords will subdivide a dwelling into many apartments. Some landlords will illegally create apartments in basements, attics, and garages. Since a landlord is required to provide a brief description of the property, the possibility exists that a landlord may try to hide the number of apartments or the number of tenants that may reside at the rental property. Based upon the information that is filed on a landlord's tax return, tax collection agencies can not easily identify landlords that are receiving rental income from illegal apartments.

To ensure that rental income is reported accurately, the present invention requires landlords to report the amount of rental income received from each tenant and that each tenant is required to report rental payments to a landlord. By having landlords to report rental income and tenants to report rental payments, tax collection agencies can cross reference this information to ensure that landlords and homeowners are reporting all rental income. Since landlords and homeowners know that tenants will have to report all rental payments, they will be more likely to accurately report all of their rental income. Not only will landlords and tenants are required to report the rental payments, but, they must report the amount of time that the apartment was leased.

Since the present invention requires landlords and homeowners to report all of the tenants at their rental properties, a new tax form will be used to report tenants that are residing in the apartments. When tenants move into an apartment, the landlord/homeowner must file a form that shows all of the people that will reside at the apartment. On this new tax form, the landlord/homeowner must report the following information for each person: name, address, social security number, monthly rent, employer, start date of lease, and expected end date of the lease.

The existing tax form, for an individual, requires that the tax filer reports all dependents. Since the possibility exists that a landlord may not be aware of everyone that is residing in an apartment, the existing tax form must be modified to allow the tenant(s) to list all of the people that reside at that residence. For each person that was listed, the tax filer will identify the individuals that are dependents and the amount of money that each person contributes to the monthly rent. The sum of money reported by the tenant(s) must be equal to the amount of money reported by the landlord.

Another major problem for tax collection agencies involves landlords that are not accurately reporting deductions and vendors that are not accurately reporting revenues generated in the housing industry. With the present system, landlords state the expenses that were paid to vendors (general contractors, plumbers, electricians, landscapers . . . ). Unless audited, landlords are not required to submit any type of proof on a tax return. It is possible that a landlord could claim a deduction for a business that did not provide any type of service or the deduction could be for more than what the landlord/homeowner paid for the service. Unless a landlord's tax return is audited, tax collection agencies are not able to confirm that a landlord's deductions are accurate. Since a very small percentage of tax returns are audited and landlords know that their chances of facing an audit are very small, the probability of unscrupulous landlords providing inaccurate information is very high.

Since enough information does not exist on the present tax returns to determine which landlords are submitting fraudulent deductions, tax collection agencies must hire more auditors to review tax returns from landlords. Under the present system, the landlord simply lists the amount of money that was paid for a service. The present invention will require landlords to associate a unique identification number to a tax deduction. The unique identification number will be composed of a code to identify the vendor and a code to identify the vendor's customer. The code to identify the vendor could be the vendor's tax identification number. The code to identify the customer could be a code provided by the vendor. By requiring landlords to identify the vendor with the payment, tax collection agencies can use information from the vendor as a cross reference. For each tax deduction that a landlord is not able to associate with a tax deduction, the probability increases that the deduction may be fraudulent. Since vendors are required to report payments from landlords and homeowners and landlords and homeowners are reporting payments to certain contractors, tax collection agencies can confirm that landlords and vendors are accurately reporting deductions and revenue. Stiff penalties and rewards will be required to prevent landlords and vendors from working together to maximize deductions for landlords and underreport revenue for the vendors.

Another major problem for tax collection agencies involves vendors (general contractors, plumbers, electricians . . . ) that do not accurately report all of their revenue from the home construction and renovation industry. Under the present system, a vendor states his revenue and business expenses. Enough information is not provided on the tax returns to confirm revenues and expenses. Unless a vendor is audited, a vendor does not have to provide any details as to how the revenue was generated. Since the probability of facing an audit is very low, the vendor may choose to underreport the revenue from some or all of his jobs.

To ensure that vendors are accurately reporting their revenues, the present invention requires vendors to provide a detail list of revenue generated from each customer. Since the vendor's customer (landlord, homeowner, business . . . ) is required to file the amount of money paid to a vendor and vendors are required to report revenues from each customer, tax collection can generate reports to confirm that the proper deductions and revenues are more accurately reported. If report indicates that the deduction/revenue does not match, the possibility exists that the claim by landlord or customer is not accurate.

The major responsibility of the United States Census Bureau is to enumerate the population of the United States every 10 years. The results of the enumeration will be used to allocate Congressional seats, electoral votes, and government program funding. In the past, many states and communities have complained that the results of the enumeration were not accurate. One of the reasons for the complaints is that Census enumerators may not have been aware of the illegal apartments or the number of people at a dwelling. Since the present invention requires landlords and residents to report all of the people in a household, the Census Bureau can use this information to increase the probability that they are able enumerate the dwellings accurately. From the information that is provided from landlords and homeowners, a centralized database will be created to contain all of the people residing in the United States.

The following are examples of ways that the present invention can be used to ensure individuals and businesses are in compliance with some of the tax laws.

### EXAMPLE A

John Smith is a landlord that owns a single family four bedroom house. To maximize his profits, Mr. Smith has decided to illegally convert the single family house into a multi-family dwelling. The basement is converted into one apartment and the attic is converted into another apartment. Even though the house is on the property tax rolls as a single family house, Mr. Smith decides to disobey the zoning laws and not obtain the proper permits.

When he files his tax return for this rental property, he continues to declare that the house is a single family dwelling. Since he knows that it highly unlikely that tax collection agencies ask tenants the amount of rent that is paid, Mr. Smith may not report the entire amount of rental income. On his tax return, he has reported that the annual rental income for this property is $14,400. In this area, the tax collection agencies know that this is about how much the annual rental income is for a single family house. Unfortunately, Mr. Smith is collecting $10,800 for the basement apartment from Adam Wright. For the apartment in the attic, he is collecting $12,000 from Robert Cox. For the rest of the house, Mr. Smith is collecting $14,400 from Scott Williams and Ann Jones.

With the present invention, Mr. Smith will be required to provide the name and social security information of each person on the lease and the total amount of money that each tenant or household is responsible for. To ensure the accuracy of the information provided by Mr. Smith, each tenant must provide the information to identify the landlord (address, apartment number) and the total amount of money that was paid to the landlord. The amount of money that Mr. Smith reports for the rental unit must match the amount of money that all of the tenants reported on their combined tax returns.

After speaking with Mr. Wright and Mr. Cox, he learns that they have no plans of filing tax returns because Mr. Wright is paid off the books and Mr. Cox is in the country illegally. Since he knows that they have said that they will not file tax returns, he takes a chance and reports the rental income for the rental property as $14,400. Suppose that Mr. Cox has to file tax returns to apply for a mortgage. On Mr. Cox's tax return, he has to report how much money was paid for his apartment. With the present invention, a report will report that the amount of rental income reported by Mr. Cox's landlord is less than all of all of the money paid to Mr. Cox. Since Mr. Cox was identified as underreporting the rental income, he will be audited. By auditing Mr. Cox, a tax collection agency can investigate him for the current year and previous years. Since he did not list Mr. Cox as a tenant, the possibility exists that he has other tenants. If landlords know that tenants have to list them on their tax returns and tenants know that landlords have to identify all of the tenants, landlords are less likely to take chances of underreporting rental income and tenants will have a much more difficult time of hiding from tax collection agencies.

### EXAMPLE B

Let assume that Mr. John Smith owns a multi-family house that has three apartments. He rents apartment A to the unmarried couple Scott Williams and Ann Jones for $1200 per month. He rents apartment B to Adam Wright for $900 per month. He rents apartment C to Robert Cox for $1000. When he rents each apartment, he files this information with the IRS. On his tax return he reports the annual rental income of $37,200. On Mr. Scott Williams's tax return, he reports that he paid Mr. John Smith $450 per month. On Ms. Ann Jones's tax return, she reported that she paid $450 per month to Mr. John Smith. On Mr. Adam Wright's tax return, he reports that he paid Mr. John Smith $900 per month.

Let us assume that Mr. Robert Cox fails to file a tax return. Since Mr. John Smith reported Mr. Robert Cox as his tenant for a specific time period and a tax return does not exist for Mr. Robert Cox for that time period, the present invention will make it much harder to hide from tax collection agencies. Suppose that Mr. Robert Cox is attempting to avoid paying child support. As he changes apartments, his landlords will be required to file a form that states that Mr. Robert Cox resides there. With this information, the appropriate authorities will have a much easier time to track him down. If individuals know that the appropriate authorities have the necessary information to track their movements, they will be more willing to comply with the laws.

### EXAMPLE C

John Smith owns a single family home that he plans to rent to tenants. He hires AAA Contractors to renovate the kitchen for $30,000. As part of the deal, AAA Contractors tells Mr. John Smith that he can save some money by paying $20,000 by check and $10,000 in cash. The reason for accepting part of the payment in cash is for AAA Contractors to attempt to hide this revenue from tax collection agencies. Since he is having this work done, Mr. Smith decides to claim additional work was done in the bathroom for $15,000 by a fictitious company known as Bath Works. He generates some phony receipts for Bath Works and Mr. Smith will claim that he did not know that the company was not legitimate. When Mr. Smith, the landlord, files his tax return, he has to associate the total payments for AAA Contractors and Bath Works to the appropriate unique identification numbers. Also, AAA Contractors will indicate on its tax returns that it received a payment from John Smith.

On the tax return for the landlord, Mr. John Smith declares the $30,000 for the amount of money paid to AAA Contractors and $15,000 for work that by Bath Works. AAA Contractors will provide some or all of its customers and the amount of money that was received from the customers. Since Mr. John Smith paid $30,000 to renovate his kitchen and he wants the full deduction, he is more likely to report $30,000 for AAA Contractors rather than $20,000. If John Smith forgets that he was to report $20,000 and reports $30,000, AAA Contractors will report that Mr. John Smith paid only $20,000. When this happens, the present invention will identify AAA Contractors as underreporting. Since Bath Works did not file a report that it received a payment of $15,000 for the bathroom from Mr. John Smith, the deduction for Bath Works is identified as a potential fraudulent deduction. If a large percentage of Mr. Smith's business expenses can not be verified with what a vendor has reported, the possibility some of Mr. Smith's deductions are fraudulent. Also, if a large percentage of AAA Contractors's expenses can not be verified to a customer, the possibility exists that AAA Contractors is underreporting his revenues.

Since contactors are not known to turn badly between consumers and contractors, a contractor will always have to live with the fear that his customer may report him for underreporting some of his revenues. By having landlords/homeowners reporting the amount of money paid to contractors and contractors reporting the amount of money received from customers, the present invention allows tax collection agencies to develop report to identify potential fraudulent deductions and to discourage the underreporting of revenues by vendors.

### EXAMPLE D

To determine the houses that will be enumerated in a Census, the Census Bureau depends upon information such as the property tax rolls to determine residences. From the property tax rolls, the dwellings are classified. Here are some of the classifications: single family, two family, and hotel.

Victor Washington is a Census Enumerator that has to obtain a Census form for a single family house. Even though it is classified as single family house, the dwelling is occupied by three families. Since Mr. Washington believes that this is a single family home, the probability is very high that he will not obtain Census forms for the other families. Also, the possibility exists that the tenants do not want Mr. Washington to know that some of the apartments in the dwelling are illegal. By requiring the landlord/homeowner to report the number of families in the dwelling, the Census Bureau will be able to obtain a more accurate account of the number of families in a dwelling.

1. A method for ensuring that landlords accurately report rental income for rental properties. All landlords must now be required to provide the name and tax identification numbers of the tenants and the amount of rental income that tenants have paid. Since it will now be a requirement that tenants report the amount of money that is paid for rent, landlords know that tax collecting agencies now have the ability to confirm the amount of rental income that is received for rental properties.

2. According to claim 1, further comprising: A method for ensuring that all tenants file a tax return. Since landlords are required to provide the tax identification numbers of all tenants, tenants are aware that tax collecting agencies are aware of their presence. When the tenants provide this information, other governmental agencies (Homeland Security, police departments . . . ) can use this information as an effective tool.

3. According to claim 1, further comprising: A method for providing a cost effective way to confirming that landlords have reported all of the rental income for a rental property. When a tenant files a return, the tenant will be required to the business tax identification number of the landlord and the amount of money that was paid to the landlord for a rental property. Since the landlord is reporting the amount of rental income received from an individual and the tenant is reporting the amount of money paid to a landlord, the tax collecting agencies will be able to confirm this.

4. According to claim 1, further comprising: A method to implement another audit checks to ensure that the tenant's income correlates to the rental property. If the gross income for the household does not correlate to the rental income, all of the tenants in household may not be accurately reported all of their income.

5. According to claim 1, further comprising: A method to ensure that the Census Bureau accurately enumerates the number of people in a house. Based upon the information that was provided by the landlords, the correct number and the type of Census forms can be provided to the households.

6. According to claim 1, further comprising: A method to ensure that every eligible person that is required to file a tax return is identified. When a prospective tenant applies for housing, the landlord must confirm that the tax identification number of each tenant is valid.

7. According to claim 1, further comprising: A method to allow Homeland Security to identify illegal immigrants and individuals that have over stayed their visas. Since landlords must report the tax identification numbers of tenants, Homeland Security will have a more effective tool of tracking individuals.

8. According to claim 1, further comprising: A method to ensure that general contractors accurately report the amount of money that is paid for home renovations. With this method, general contractors are required to provide homeowners with their business tax identification number and a customer number. The general contractor will provide the business tax identification number and customer id number to show the payment from the homeowner on his tax return. When the homeowner files his return, the business tax identification number and customer id number will be used to indicate a payment to a contractor. The tax collecting agencies will correlate the information from the homeowners and contractors to confirm that contractors are accurately reporting income and landlords are accurately reporting deductions.
